(19) United States
(12) Patent Application Publication
(10) Pub. No.: US 2007/0300077 A1
(43) Pub. Date: Dec. 27, 2007

(54) METHOD AND APPARATUS FOR BIOMETRIC VERIFICATION OF SECONDARY AUTHENTICATIONS

(76) Inventors: Seshadri Mani, Surrey (CA); Manjit S. Bhasin, Surrey (CA); Gregory H. Wood, Redmond, WA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/426,568

(22) Filed: Jun. 26, 2006

(51) Int. Cl. H04K 1/00

(52) U.S. Cl. 713/186

(57) ABSTRACT

Methods and software to alter secondary authentication procedures of a program by detecting the secondary user authentication, interposing a biometric data collection, validating the collected biometric data, and continuing with a user operation if the validation is successful, are described and claimed. Software to support such operations, and systems using the methods, are also described and claimed.

### FIELD

The invention relates to user authentication in computer systems. More specifically, the invention relates to methods for extending biometric user authentication procedures to authentications that may be required after an initial login.

### BACKGROUND

Computer systems often contain valuable and/or sensitive information, control access to such information, or play an integral role in securing physical locations and assets. The security of information, assets and locations is only as good as the weakest link in the security chain, so it is important that computers reliably be able to distinguish authorized personnel from imposters. In the past, computer security has largely depended on secret passwords. Unfortunately, users often choose passwords that are easy to guess or that are simple enough to determine via exhaustive search or other means. When passwords of greater complexity are assigned, users may find them hard to remember, so may write them down, thus creating a new, different security vulnerability.

Various approaches have been tried to improve the security of computer systems. For example, in “know something, have something” schemes, a prospective user must know a password (or other secret code) and have (or prove possession of) a physical token such as a key or an identification card. Such schemes usually provide better authentication than passwords alone, but an authorized user can still permit an unauthorized user to use the system simply by giving the token and the secret code to the unauthorized user.

Other authentication methods rely on measurements of unique physical characteristics (“biometrics”) of users to identify authorized users. For example, fingerprints, voice patterns and retinal images have all been used with some success. However, these methods usually require special hardware to implement (e.g. fingerprint or retinal cameras; audio input facilities).

Techniques have been developed that permit computer users to be authenticated at machines without any special hardware. For example, U.S. Pat. No. 4,805,222 to Young et al. describes verifying the identity of an individual based on timing data collected while he types on a keyboard. Identification is accomplished by a simple statistical method that treats the collected data as an n-dimensional vector and computes the distance between this vector and a target vector. More sophisticated analyses have also been proposed. For example, U.S. Pat. No. 6,151,593 to Cho et al. suggests using a neural network to classify keystroke timing vectors.

Biometric data collection (both with special hardware and with creative uses of standard hardware) has been integrated into the primary authentication sequences that occur when a user first begins to interact with a computer system. Only a relatively small number of different login methods are in common use, so adapting them to collect and verify biometric information is not an overwhelming task. However, some application programs that a user may invoke after initially establishing his identity to the operating system require a second authentication cycle. For example, a user may wish to connect to a second computer from the first computer using credentials different from what he used for logging in. The program to accomplish this connection may query the user for a password or other identifying information to present to the second computer. As another example, system administrators often log in using a normal account without unusual, elevated privileges when performing tasks that do not require special privileges. This helps prevent inadvertent system damage due to typos and operational errors. When the administrator wishes to use a privileged command, he will perform a secondary authentication process to obtain the necessary privileges (and then relinquish those privileges after completing the task). It may be desired to improve the security and reliability of these “secondary authentications” by collecting and validating biometric data, as has been done for primary authentications. Unfortunately, many operating systems lack a standardized method for performing secondary authentications, so there may be no accessible program sequence that can be modified to add biometric security to most or all secondary authentications.

Some work has been done on this problem: existing systems can detect when a program that performs a secondary authentication is started, then terminate the program, collect and validate biometric data, and re-start the program. However, this approach often results in a double authentication: the user is required to establish his identity once to a biometric authenticator, and then again to a legacy secondary authentication process (such as a simple password entry) of the program. Users (understandably) find this double authentication annoying.

Improved methods of augmenting secondary authentication procedures with biometric data verification may be of value in this field.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows systems and facilities of an environment that can use an embodiment of the invention.

FIG. 2 is an overview of operations according to an embodiment of the invention.

FIG. 3 details one way an embodiment can augment a secondary authentication with a biometric data verification.

FIG. 4 shows a second way an embodiment can augment a secondary authentication with a biometric data verification.

FIG. 5 shows operations of a network authentication server that can cooperate with an embodiment and thwart some attempts to evade biometric verification of secondary authentications.

### DETAILED DESCRIPTION

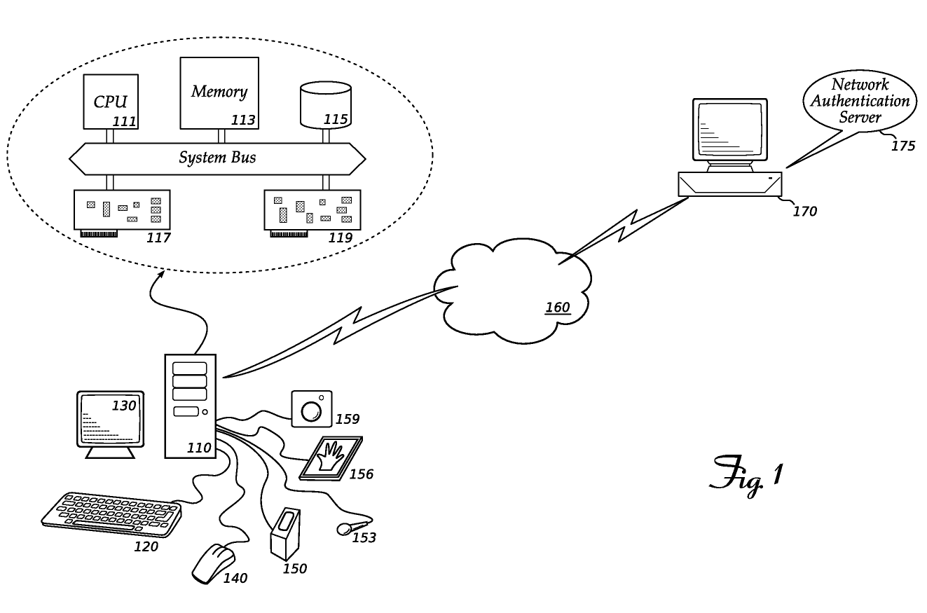

FIG. 1 shows an overview of an environment where an embodiment of the invention can be deployed. Element 110 is a standard personal computer (“PC”) system; such systems usually include a keyboard 120, display 130 and mouse (or other pointing device) 140. These basic components are sufficient to collect biometric data for improved-security user authentication. However, a system may also include special hardware to collect other biometric data. Examples of such hardware include fingerprint imager 150, microphone 153 for recording voice waveforms, finger-length sensor 156 to measure a user's hand geometry, or camera 159 for use in connection with a face-recognition system.

Computer system 110 conventionally includes components like those shown in the inset: a programmable processor or central processing unit (“CPU”) 111, memory 113, mass storage device 115, and hardware interface adapters 117 and 119. An operating system (“OS,” not indicated in this Figure) contains machine instructions to cause the programmable processor to perform operations as directed by a user of the system. It is frequently a responsibility of a service (like Winlogon service in the Windows™ OS by Microsoft Corporation of Redmond, Wash.) integrated with OS to identify the user and to prevent access by unauthorized individuals.

System 110 may communicate via a data network 160 (e.g. a local area network (“LAN”), wide area network (“WAN”), or similar distributed data network) with a remote system 170; as shown here, remote system 170 may provide a network authentication server 175 to assist the OS of system 110 in identifying users and controlling access.

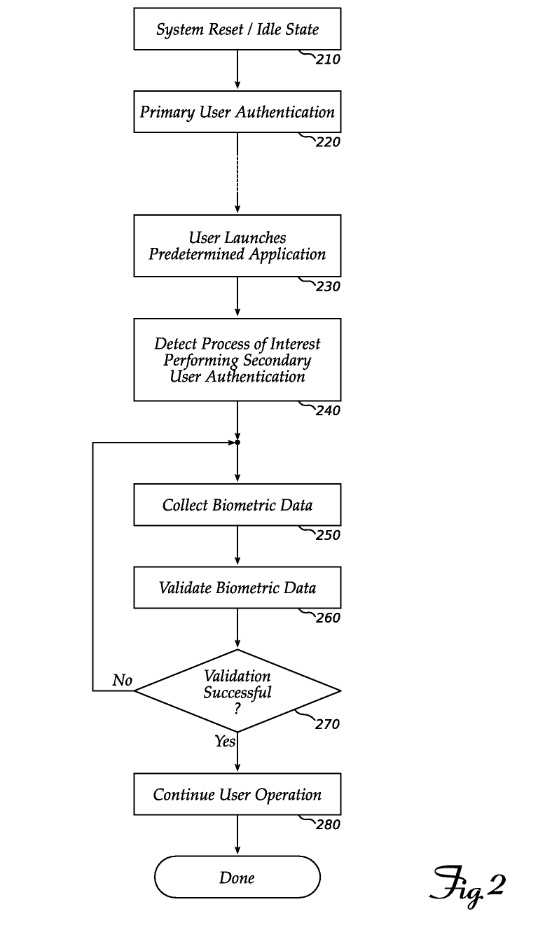

FIG. 2 outlines a sequence of events that may occur as a user operates a computer system that implements an embodiment of the invention. From a system reset or idle state (210), a user completes a primary authentication process (220). The idle state may occur after the machine is reset or powered on, or after a previous user has terminated his session and logged out. The primary user authentication may involve entering a username and password, connecting a key or token to the system, submitting to a biometric measurement process, or some combination of these or similar actions.

After the primary user authentication, the user has established his identity to the computer and may use data and resources available under the applicable security conditions. Eventually, the user may launch a predetermined application (230), and the application may perform a secondary user authentication cycle. The secondary authentication cycle may be to prevent unauthorized use by an opportunist who comes upon the system while the authenticated user has stepped away momentarily, to establish a right to use a resource protected by an enhanced level of security, to identify the authorized user to a remote system from which data or service is sought, to gain enhanced privileges by legitimate system administrators and perform their administrative tasks or another similar purpose.

An embodiment of the invention detects that a process of interest is performing a secondary user authentication (240) and interposes a biometric data collection operation (250) to collect one or more measurements of a physical and/or behavioral characteristic of the user. For example, a fingerprint image, retinal image, hand geometry measurement, or voice impression may be obtained. In a preferred embodiment, keystroke timing measurements are collected while the user enters a string such as his name, password, or a common phrase in a login-like user interface window.

Next, the collected biometric data are validated (260) by comparing them against previously collected data stored on the server (or cached locally on the system) or local system, by transmitting the measurements to a remote authentication server or, in the case of an offline scenario, to a local service, or by another similar means. If the validation is successful (270), the embodiment may permit (or direct) the predetermined application to proceed with the user operation that triggered the secondary user authentication (280). If the validation is unsuccessful, the embodiment may permit the user to try to authenticate again by collecting (250) and validating (260) new biometric data.

Note that embodiments of the invention override or replace the legacy secondary user authentication procedure normally performed by the application. For example, an application might normally request that the user enter his password before continuing. An embodiment of the invention may collect biometric data instead of a password, or in addition to the password. In a system that uses keystroke timing measurements as a biometric data source, the timing measurements may be collected while the user types his password. Thus, an embodiment may use both legacy authentication data (the password) and biometric authentication data (the timings collected while the user types the password) to perform the secondary user authentication. However, when the application is permitted or directed to continue, the authentication has already been performed, so the application need not request that the user type his password again.

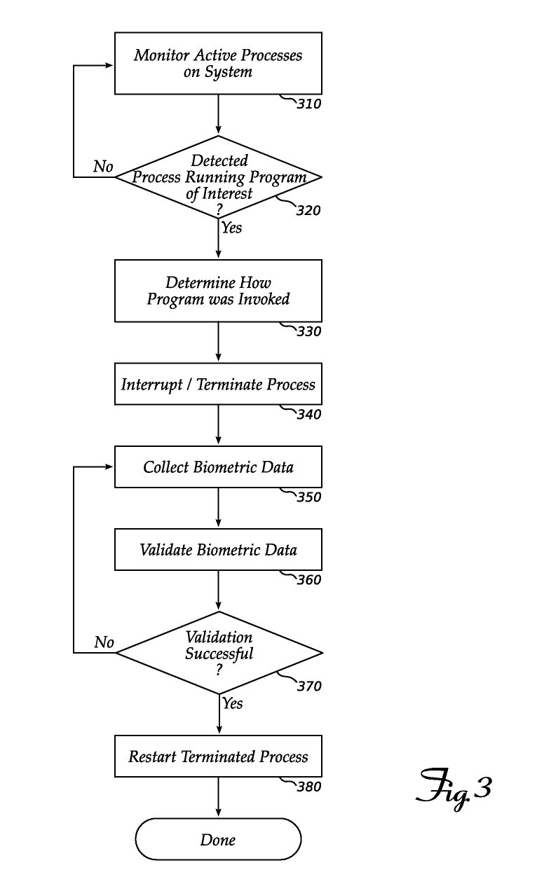

FIG. 3 explains one way an embodiment of the invention can interpose a biometric data collection and validation sequence where an application would normally perform a secondary user authentication. This embodiment will be described in terms familiar to programmers who produce applications for use on the Windows™ operating system from Microsoft Corporation of Redmond, Wash. However, those of ordinary skill working on other platforms can apply the ideas discussed here to those other systems.

A first portion of this embodiment monitors active processes executing on the computer system (310). On Windows™, this monitoring can be accomplished with an operating system function called “EnumProcesses” (for “enumerate processes”). The embodiment can search the list of running processes for one (or more) that is running a program of interest. Programs of interest can be identified by names stored, for example, in a database or registry entry. If no process is running a program of interest (320), the embodiment simply continues to monitor active processes (310). If a process running a program of interest is detected (320), the embodiment determines how the program was invoked (330). For example, on Windows™, command line parameters may be displayed in the title bar of a user interface window presented by the program, so an embodiment can retrieve invocation information from the title of the window. Under other systems, command line parameters may be available through a programmatic interface to the environment of the process of interest. If some information about the program is unavailable, an embodiment can collect the information from the user (as described below). After collecting invocation information, the process is interrupted or terminated (340). On Windows™, this can be achieved by the “TerminateProcess” system function.

Next, the embodiment collects biometric data of the user (350). This may entail starting a new process to present a message or sequence of messages to the user, configuring and operating special measurement-collecting hardware, and so on. The biometric data collection process may also collect legacy authentication information such as a username or a password. At this time, any program invocation information that could not be automatically determined may also be collected from the user. After that, the collected biometric data is validated (360). Validation may also include checking legacy data (e.g. username and password) collected. If the validation is not successful (370), the collection and validation may be repeated until acceptable data is collected, or until a configurable maximum number of failures is reached. If the user is unable to validate successfully, he will be denied access to the program of interest.

If the validation is successful (370), the embodiment starts a new instance of the process with the program of interest (380), using the information collected earlier about how the program was invoked. In a preferred embodiment, the termination and restart procedure is transparent to the user: he will not notice that the program was stopped and restarted. For some programs, it may be possible to provide legacy authentication information through a command-line parameter or inter-process communication channel so that the program does not display a second (legacy) authentication dialog. Commonly-used programs on Microsoft Windows™ systems that are amenable to this approach include NET USE, which allows a user at one computer to access a resource of another computer; and RUNAS, which allows a user to start a program that will run as if it was started by a second user (often, the second user has greater privileges than the first user).

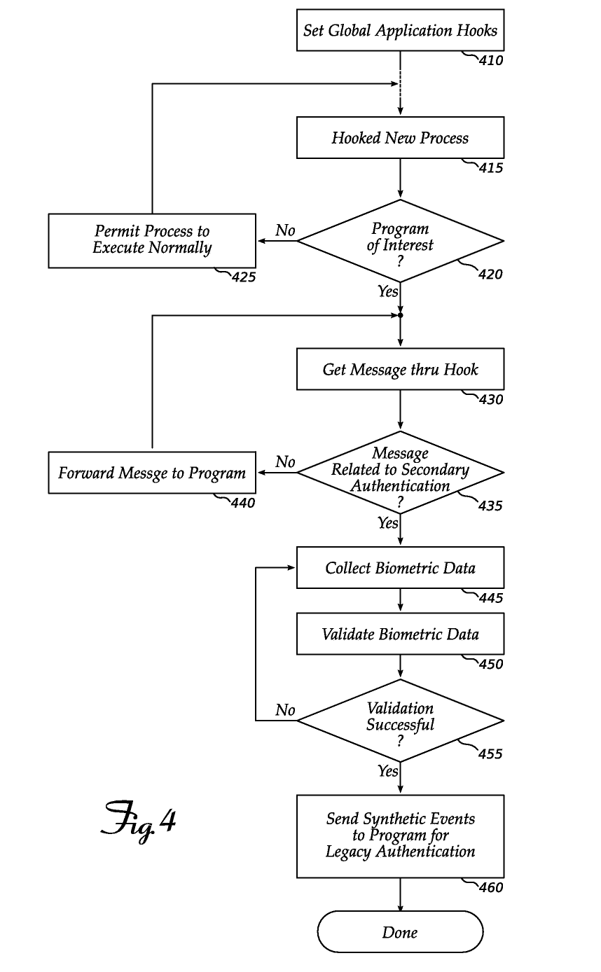

Embodiments can replace a legacy secondary authentication process of a program with a biometric authentication in another way. This will be described with reference to FIG. 4. This approach may be more effective with programs that are commonly started and operated from a graphical user interface (“GUI”) instead of a text-based command line. For example, in Windows OS, the “Connect As” mechanism brings up user interface to perform secondary authentication to a second system from the current system where the user is logged in.

First, this embodiment installs a global “hook” function that will be given the opportunity to observe and/or process messages between applications and the operating system (“OS”) (410). On Windows™, the “SetWindowsHookEx” function can install such a hook. The embodiment may contain a database or registry entry that holds the process names (like ‘xyzproc.exe’) and names of user interface windows (like ‘Enter network password’) that are of interest. Some embodiments may track individual fields within a user interface window to detect programs performing a secondary user authentication. For example, a text entry field named “Network Password” may indicate a secondary authentication in progress. In a Windows™ network environment, an Active Directory (“AD”) database or Structured Query Language (“SQL”) server database may be available to hold program, window, and field names of interest. When a new process is hooked (415), the embodiment reviews a database or registry entry listing of process names of interest. If the new process is not of interest (420), it is permitted to execute normally (425). If the new process is of interest (e.g. because it is known to perform secondary user authentications), then the embodiment performs a second review on database or registry entry of user interface window names. Once the user interface window name of interest is identified then the user interface window event messages are biometrically hooked and will be examined further. Alternatively, this user interface window can be hidden and physical biometric verification can be performed using fingerprint, voice, etc.

When a message is obtained by the hook function (430), it is examined to determine whether it is related to a secondary authentication process. If it is not (435), the message is forwarded to the program for normal processing (440). If the message is related to a secondary authentication (435), the embodiment collects biometric data (445) and validates the data (450), as in other embodiments. If the validation is not successful (445), the user may be permitted to try again.

If the validation is successful, the hooked program is permitted to continue. In some embodiments, the hook function's access to the program's message stream may be exploited to send synthetic messages or events to the program (460). These synthetic events may be useful to cause the program to operate as if it had performed the legacy secondary authentication.

For example, if the program normally creates a user interface window to prompt the user for a password, then collects keystrokes followed by a click of an “OK” button, the embodiment could hide the user interface window message and transmit a series of synthetic keystroke messages followed by an activation of the “OK” button to drive the program's logic through the legacy secondary authentication section and into the subsequent activities.

Note that similar hook capabilities are available in user interfaces and operating systems other than Microsoft Windows™, so embodiments of the invention can be applied in non-Windows environments. Some environments provide shared libraries or dynamically-loaded libraries (“DLLs”) that can be used to insert or interpose executable instructions to perform methods according to embodiments of the invention into existing programs' logic sequences. When a library overrides functions in this way, the overridden functions are said to be “shadowed.”

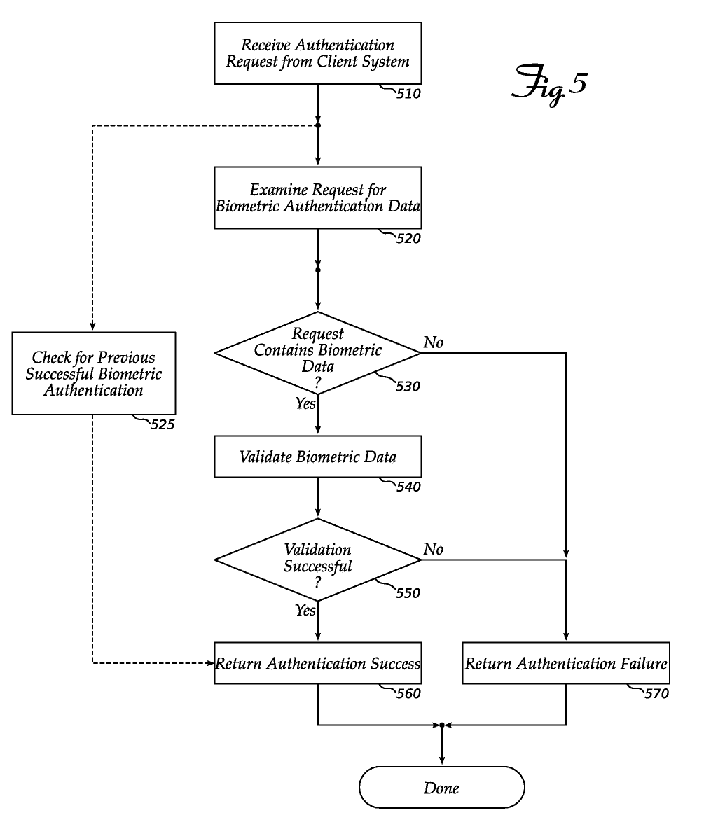

One difficulty that may be encountered in some embodiments that monitor active processes to detect programs that may perform secondary authentications is that such programs may execute so quickly that they are not detected. Indeed, a malicious user may prepare a batch file or use the aforementioned synthetic event facility to increase the likelihood of a program execution escaping the notice of the monitor (and consequently operating with less-secure, legacy, password-only authentication). To reduce the impact of such inadvertent or intentional rapid program execution, an embodiment may cooperate with a second logic module executing at a network authentication server. This is shown in FIG. 5.

As mentioned earlier, some computer systems operate within a network, and some user authentication procedures may be performed by a remote system. For example, in Windows™ networks, a “domain controller” performs some authentication tasks. It may use Active Directory (“AD”) to store credential information and the Lightweight Directory Access Protocol (“LDAP”) to process authentication requests. A network authentication server such as an LDAP server or a domain controller may receive an authentication request from a client system (510), the request to include information such as the user's name and password. Normally, the password would be checked against a database and a “go/no-go” response returned to the client. However, according to an embodiment of the invention, the network authentication server may examine the request to determine whether it includes biometric data to identify the user (520) or through some biometric authentication modules running on the server confirm whether the user is already biometrically authenticated. If there is no such data (530), a “no-go” response may be returned (570) regardless of whether any password transmitted with the request is correct. If the request includes biometric data (530), the data may be validated (540) and a “go/no-go” response returned (560, 570) based on the result of the validation (550). Protocol requests and responses may be transmitted according to any format commonly accepted between client and server. LDAP is one widely-used protocol format.

Some embodiments may keep a cache of recent successful biometric authentications, either at the client system or at the authentication server. This cache may permit much of the processing described with reference to FIG. 5 to be circumvented, as shown in element 525.

Authentication server operations as shown in FIG. 5 can thwart some client-side attacks that attempt to evade a process monitor's notice and obtain authenticated access through legacy (non-biometric) authentication means without collecting or transmitting biometric identification data.

An embodiment of the invention may be a machine-readable medium having stored thereon instructions which cause a programmable processor to perform operations as described above. In other embodiments, the operations might be performed by specific hardware components that contain hardwired logic. Those operations might alternatively be performed by any combination of programmed computer components and custom hardware components.

A machine-readable medium may include any mechanism for storing or transmitting information in a form readable by a machine (e.g., a computer), including but not limited to Compact Disc Read-Only Memory (CD-ROM), Read-Only Memory (ROM), Random Access Memory (RAM), and Erasable Programmable Read-Only Memory (EPROM).

The applications of the present invention have been described largely by reference to specific examples and in terms of particular allocations of functionality to certain hardware and/or software components. However, those of skill in the art will recognize that biometric verification of secondary authentications can also be produced by software and hardware that distribute the functions of embodiments of this invention differently than herein described. Such variations and implementations are understood to be captured according to the following claims.

We claim:

1. A method of enhancing security of secondary user authentications using biometric verification, comprising:
detecting a secondary user authentication in connection with a user operation;
interposing a biometric data collection;
validating collected biometric data; and
continuing with the user operation if the collected biometric data is successfully validated.

2. The method of claim 1 wherein the biometric data collection replaces a legacy identification information collection.

3. The method of claim 2 wherein the legacy identification information collection is a password entry.

4. The method of claim 1 wherein the biometric data comprises keystroke timings of a plurality of keystrokes.

5. The method of claim 1, further comprising:
monitoring active processes on a computer system, wherein
detecting includes searching through the active processes to find one of a plurality of processes that are known to perform the secondary user authentication.

6. The method of claim 1, further comprising:
shadowing a legacy function with an updated function, wherein
detecting includes executing the updated function if the secondary user authentication commences.

7. The method of claim 1 wherein interposing comprises:
terminating an active process associated with the secondary user authentication; and
starting a new process to collect biometric data.

8. The method of claim 1 wherein interposing comprises:
hooking an event handler of a legacy user interface; and
collecting biometric data through the event handler.

9. A system comprising:
means for intercepting a secondary user authentication in connection with a user operation;
means for collecting biometric data;
means for validating the biometric data; and
means for resuming the user operation if the biometric data is successfully validated.

10. The system of claim 9 wherein the means for collecting biometric data comprises:
a keyboard to enter a plurality of keystrokes; and
timing means to measure a delay between a first keystroke and a second keystroke.

11. The system of claim 9 wherein the means for intercepting a secondary user authentication comprises:
a library of executable instructions to be executed in connection with the secondary user authentication.

12. The system of claim 9, further comprising:
means for monitoring a plurality of processes executing on the system; and
means for interrupting one of the plurality of processes if the process performs a secondary user authentication; and
means for verifying user interface window names that are meant for secondary authentications.

13. The system of claim 9, further comprising:
a database to identify processes or user interface window names that are known to perform secondary user authentications.

14. The system of claim 9, further comprising:
a registry entry to identify processes or user interface window names that are known to perform secondary user authentications.

15. The system of claim 9, further comprising:
A directory service object that contains the list of processes and user interface window names known to perform secondary user authentications

16. A machine-readable medium containing instructions to cause a programmable processor to perform operations comprising:
receiving an authentication request from a client system;
examining the request to determine whether the request includes biometric data;
returning an authentication failure response if the request lacks biometric data;
validating the biometric data if the request includes biometric data; and
returning an authentication success response if the biometric data is successfully validated.

17. The machine-readable medium of claim 16 wherein the authentication request and authentication failure response or authentication success response conform to a primary domain controller protocol.

18. The machine-readable medium of claim 16 wherein the authentication request and authentication failure response or authentication success response conform to a lightweight directory access protocol (“LDAP”).

19. The machine-readable medium of claim 16, containing additional instructions to cause the programmable processor to perform operations comprising:
identifying a user associated with the authentication request; and
determining whether an authentication request for the user requires biometric data.

20. A machine-readable medium containing instructions to cause a programmable processor to perform operations comprising:
detecting a secondary user authentication event that is to establish an identity of a user;
collecting biometric data associated with the user;
validating the biometric data; and
authorizing a process to operate as the user if the biometric data is successfully validated.

21. The machine-readable medium of claim 20, containing additional instructions to cause the programmable processor to perform operations comprising:
displaying a user-interface window to collect a password; and
measuring a delay time between a first keystroke and a second keystroke of the password.

22. The machine-readable medium of claim 20, containing additional instructions to cause the programmable processor to perform operations comprising:
intercepting event messages from a user interface system; and
creating synthetic event messages to be transmitted to a legacy user authentication process.
